(19) United States
(12) Patent Application Publication
(10) Pub. No.: US 2018/0260168 A1
(43) Pub. Date: Sep. 13, 2018

(54) LABEL PRINTER APPLICATOR SYSTEM

(71) Applicant: Van Loi Le, Mission Viejo, CA (US)

(72) Inventor: Van Loi Le, Mission Viejo, CA (US)

(21) Appl. No.: 15/919,238

(22) Filed: Mar. 13, 2018

Related U.S. Application Data
(63) Continuation of application No. 15/095,084, filed on Apr. 10, 2016, now abandoned.

(51) Int. Cl. G06F 3/12; H04N 1/23; B41J 3/407; B65C 1/02; B65C 9/46; B65C 9/40

(52) U.S. Cl. CPC G06F 3/1206; G06F 3/1244; H04N 1/2323; B65C 2009/0003; B65C 1/021; B65C 9/46; B65C 9/40; B41J 3/4075

(57) ABSTRACT

A printer system, comprising: a print and apply device configured to print or encode a label and apply the label to a package, wherein the device has a printer/encoder portion and an applicator portion; a first motor to move the print and apply device in an X-direction; a second motor to move the print and apply device in a Y-direction; a third motor to move the print and apply device in a Z-direction; a controller coupled to the print and apply device and having a single interface configured to receive a first single data stream comprising label data from the first single data stream; and a command parser configured to receive the first single data stream and parse the label data to the printer/encoder; the controller is further configured to receive a second single data stream comprising positioning data from the second single data stream; and the command parser configured to receive the second single data stream and parse the positioning data to the applicator portion.

### FIELD OF USE

The present invention relates to labeling systems, and in particular, to systems for applying labels to specific areas of packages or boxes.

### BACKGROUND

Typically, products stored in cartons or boxes are identified by a label on the outside of the carton or box. Identifying information may also be printed directly onto the carton with inkjet or any other suitable printing technology. The label may have optically readable information, such as a UPC barcode. These labels allow optical readers using a laser beam to scan the information contained thereon, such as description, price, date packaged, or any other usable data. One disadvantage of optically readable labels is that the optical reader and the label must be within a specific spatial relationship to each other, such as within a line of sight or along a perpendicular scan direction, or is limited in range by the optical reader.

A more recent type of label uses RFID or Radio Frequency Identification tags to store information. RFID uses radio frequency signals to acquire the data from the data within range of an RFID reader. RFID transponders or tags, either active or passive, are typically used with the RFID reader to read information from the RFID tag embedded in a label. RFID tags and labels can be obtained through companies such as Alien Technology Corporation of Morgan Hill, Calif.

One advantage of RFID labels is that line of sight is no longer required to read the label. This is a significant advantage since with barcodes, anything blocking the laser beam from the barcode would prevent the barcode from being read. Using radio frequencies allows RFID labels to be read through solid objects located between the RFID label and the RFID reader.

With either type of label, there may be optimal or more desirable locations on a carton, box, or package to attach the label. For example, for a decorative box to be used at a store for purchase by consumers, it may be desirable to place the label discretely on a corner so that more of the box can be used for visuals. For a carton used in a warehouse, it may be desirable to place the label near the center of the carton for ease of reading, since aesthetics would not be as important as for the store box.

U.S. Pat. No. 8,365,788, discloses a label application device that could be set for specific X, Y, and Z coordinates to allow for label placements for different size boxes. Thus, as the size, shape and dimensions of boxes changed, the specific X, Y, and Z coordinates remained absolute. However, this method for placing a label on a box does not easily allow different label placements for boxes of various skew angles or where a box is placed not in perfect alignment of the axes.

Thus, instead of altering the X, Y, and Z coordinates of the label, the X, Y, and Z coordinates of the box may need to be manipulated.

Accordingly, there is a need for label application systems that can apply labels onto packages that overcomes the deficiencies in the prior art as discussed above. One object of the invention is to provide a solution that can eliminate the need to reposition the (skewed) box to align perfectly with the x, y and z axes for the 3 dimension label printer to function properly and to be able to print the label that is aligned to edges thus saving time in aligning the boxes before affixing the label.

### SUMMARY

According to one aspect of the invention, coordinate data, such as x, y, z coordinates, is first sent to a printer system, which identifies coordinates where a label is to be placed or applied on a package. The coordinate data can be sent as part of the data stream carrying the printing or encoding information for the label and can be from any third party software such as any warehouse management software, label printing software, SAP Drivers, or any database drivers. When the printer system receives this data stream, the printer system, such as through a controller, will move and/or rotate independent motors (e.g., x, y, and/or z axis motors) in the appropriate directions to position the applicator or package in the desired position. For example, the independent motors may be moved and/or rotated in appropriate directions until the skew angle of the package is determined to be within an acceptable approach to zero. This can be done while the printer system is printing or encoding the label. Once each motor has been moved to its destination position, signals are sent back to the controller reporting the position. Once all three motors are ready, the printer system sends an apply signal to the applicator, which applies the label at the desired location on the package.

As a result, labels can be easily and quickly placed anywhere on a package. For example, two consecutive labels can be placed at the same relative position on different sized packages or at different positions on the same sized packages. This enables labels to be applied to locations most desirable for a certain package and use.

In one aspect, a invention is disclosed where a printer system, comprising: a print and apply device configured to print or encode a label and apply the label to a package, wherein the device has a printer/encoder portion and an applicator portion; a first motor to move the print and apply device in an X-direction; a second motor to move the print and apply device in a Y-direction; a third motor to move the print and apply device in a Z-direction; a first supplemental motor to rotate the print and apply device along the X-axis; a second supplemental motor to rotate the print and apply device along the Y-axis; a third supplemental motor to rotate the print and apply device along the Z-axis; a camera for determining if said package is within field of view; a sensor for detecting skew angle of said package; a controller coupled to the print and apply device and having a single interface configured to receive a single data stream comprising label data and positioning data from a single data stream; and a command parser configured to receive the single data stream and parse label data to the printer/encoder portion and positioning data to the applicator portion. In one embodiment, the controller is integral with the print and apply device. In one embodiment, the data stream is received from a host device. In one embodiment, the package can be of any size. In one embodiment, further comprising a conveyor to move the package across the print and apply device. In one embodiment, the print and apply device is located above the package. In one embodiment, the print and apply device is located along a side of the package. In one embodiment, the positioning data comprises a first distance from a leading edge of the package. In one embodiment, the positioning data comprises a second distance from a side edge of the package. In one embodiment, the label is a barcode label.

A printer system, comprising: a print and apply device configured to print or encode a label and apply the label to a package, wherein the device has a printer/encoder portion and an applicator portion; a first motor to move the package in an X-direction; a second motor to move the package in a Y-direction; a third motor to move the package in a Z-direction; a first supplemental motor to rotate the package along the X-axis; a second supplemental motor to rotate the package along the Y-axis; a third supplemental motor to rotate the package along the Z-axis; a camera for determining if said package is within field of view; a sensor for detecting skew angle of said package; a controller coupled to the print and apply device and having a single interface configured to receive a single data stream comprising label data and positioning data from a single data stream; and a command parser configured to receive the single data stream and parse label data to the printer/encoder portion and positioning data to the applicator portion. In one embodiment, the controller is integral with the print and apply device. In one embodiment, the data stream is received from a host device. In one embodiment, the package can be of any size. In one embodiment, the invention comprising a conveyor to move the package across the print and apply device. In one embodiment the print and apply device is located above the package. In one embodiment, the print and apply device is located along a side of the package. In one embodiment, the positioning data comprises a first distance from a leading edge of the package. In one embodiment, the positioning data comprises a second distance from a side edge of the package. In one embodiment, the label is a barcode label.

In yet another aspect of the invention, a printer system is disclosed, comprising: a print and apply device configured to print or encode a label and apply the label to a package, wherein the device has a printer or encoder portion and an applicator portion; a first motor to move the print and apply device in an X-direction; a second motor to move the print and apply device in a Y-direction; a third motor to move the print and apply device in a Z-direction; a controller coupled to the print and apply device and having a single interface configured to receive a first single data stream comprising label data from the first single data stream; and a command parser configured to receive the first single data stream and parse the label data to the printer/encoder; the controller is further configured to receive a second single data stream comprising positioning data from the second single data stream; and the command parser configured to receive the second single data stream and parse the positioning data to the applicator portion. In another embodiment, the system is further comprised of a first server hosting and delivering the first single data stream. In another embodiment, the system is further comprised of a second server hosting and delivering the second single data stream. In yet another aspect of the invention, a printer system is disclosed, comprising: a print and apply device configured to print or encode a label and apply the label to a package, wherein the device has a printer/encoder portion and an applicator portion; a first motor to move the print and apply device in an X-direction;a second motor to move the print and apply device in a Y-direction; a third motor to move the print and apply device in a Z-direction; a first supplemental motor to rotate the print and apply device along the X-axis; a second supplemental motor to rotate the print and apply device along the Y-axis; a third supplemental motor to rotate the print and apply device along the Z-axis; a camera for determining if the package is within field of view;a sensor for detecting skew angle of the package; a controller coupled to the print and apply device and having a single interface configured to receive a first single data stream comprising label data from the first single data stream; and a command parser configured to receive the first single data stream and parse the label data to the printer/encoder; the controller is further configured to receive a second single data stream comprising positioning data from the second single data stream; and the command parser configured to receive the second single data stream and parse the positioning data to the applicator portion. In another embodiment, the system is further comprised of a first server hosting and delivering the first single data stream. In another embodiment the system is further comprised of a second server hosting and delivering the second single data stream. In yet another aspect of the invention, a printer system, comprising: a first print and apply device configured to print or encode a label and apply one or more label to one or more packages, wherein the device has a printer/encoder portion and an applicator portion; a first motor to move the print and apply device in an X-direction; a second motor to move the print and apply device in a Y-direction; third motor to move the print and apply device in a Z-direction; a second print and apply device configured to print or encode a second label and apply the one or more label to the one or more package, wherein the device has a printer/encoder portion and an applicator portion; a first motor to move the print and apply device in an X-direction; a second motor to move the print and apply device in a Y-direction; a third motor to move the print and apply device in a Z-direction; a switching device that delivers the one or more packages to the first or second print and apply device on request; a controller coupled to the print and apply device and having a single interface configured to receive a first single data stream comprising label data from the first single data stream; and a command parser configured to receive the first single data stream and parse the label data to the printer/encoder; the controller is further configured to receive a second single data stream comprising positioning data from the second single data stream; and the command parser configured to receive the second single data stream and parse the positioning data to the applicator portion. In another embodiment, the system is further comprised of a first server hosting and delivering the first single data stream. In another embodiment, the system is further comprised of a second server hosting and delivering the second single data stream. In another embodiment, a printer system, comprising a first print and apply device configured to print or encode one or more label and apply the label to one or more package; wherein the first print and apply device has a printer/encoder portion and an applicator portion; a first motor to move the print and apply device in an X-direction;a second motor to move the print and apply device in a Y-direction; a third motor to move the print and apply device in a Z-direction; a first supplemental motor to rotate the print and apply device along the X-axis; a second supplemental motor to rotate the print and apply device along the Y-axis; a third supplemental motor to rotate the print and apply device along the Z-axis; a camera for determining if the package is within field of view; a sensor for detecting skew angle of the package; a second print and apply device configured to print or encode the one or more label and apply the label to the one or more package; wherein the second print and apply device has a printer/encoder portion and an applicator portion; a first motor to move the print and apply device in an X-direction; a second motor to move the print and apply device in a Y-direction; a third motor to move the print and apply device in a Z-direction; a first supplemental motor to rotate the print and apply device along the X-axis; a second supplemental motor to rotate the print and apply device along the Y-axis; a third supplemental motor to rotate the print and apply device along the Z-axis; a camera for determining if the package is within field of view; a sensor for detecting skew angle of the package; a switching device that delivers the one or more packages to the first or second print and apply device on request; a controller coupled to the print and apply device and having a single interface configured to receive a first single data stream comprising label data from the first single data stream; and a command parser configured to receive the first single data stream and parse the label data to the printer/encoder; the controller is further configured to receive a second single data stream comprising positioning data from the second single data stream; and the command parser configured to receive the second single data stream and parse the positioning data to the applicator portion. In another embodiment, the system is further comprised of a first server hosting and delivering the first single data stream. In another embodiment, the system is further comprised of a second server hosting and delivering the second single data stream.

This invention will be more fully understood in conjunction with the following detailed description taken together with the following drawings.

### BRIEF DESCRIPTION OF THE DRAWINGS

FIG. 1 shows a diagram of a printer system for applying labels according to one embodiment;

FIG. 2 is a block diagram of a portion of the printer system of FIG. 1 according to one embodiment;

FIG. 3 shows an example command for use with the printer system of FIG. 1; and

FIG. 4 is a flow chart showing a process for applying a label anywhere on a package, according to one embodiment.

FIG. 5 illustrates the flow diagram for one implementation of the methods of accommodating skewed boxes used with the printer system.

FIG. 6 is a perspective view of the printer system using an angle image capture device and an auxiliary digital image sensor for determining document skew.

FIG. 7 shows another embodiment of the present invention.

FIG. 8A shows another embodiment of the present invention.

FIG. 8B shows another embodiment of the present invention.

FIG. 9 shows another embodiment of the present invention.

Use of the same or similar reference numbers in different figures indicates same or like elements.

### DETAILED DESCRIPTION OF ILLUSTRATIVE EMBODIMENTS

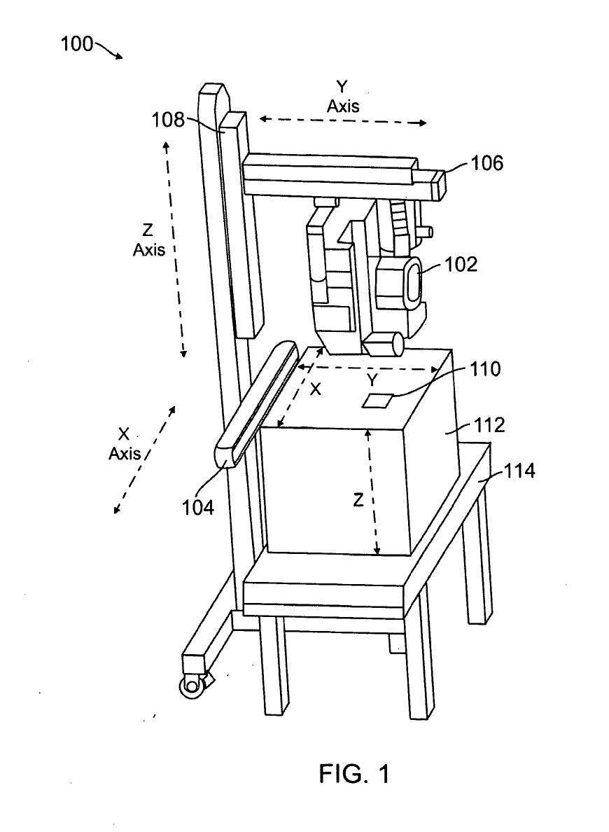

FIG. 1 shows a block diagram of a printer system 100 for applying labels to packages, according to one embodiment. System 100 includes a print and apply device or machine 102, which can receive information via a data stream from a host computer (not shown) that includes a host application, typically specific to the system through an electrical and software interface. Print and apply device 102 is commonly known and available, such as through the Printronix SLPA 8000 or Vanomation LPA 1000 models. In one embodiment, the host computer can be a conventional personal computer coupled to a local area network (LAN) or a PLC (Programmable Logic Controller connected thru serial port and/or Inputs/Outputs signals. The electrical interface can be any suitable communication means, such as, but not limited to, a serial or parallel physical link, an Ethernet connection, or a wireless link. The data stream contains various commands, such as line, box, font, and barcode commands, for printing lines, boxes, text, barcodes, and other images. The data stream is transmitted to the printer portion of print and apply machine 102 in specific languages to cause the printer to print an image on a label or other media.

Typically, each manufacturer uses a unique and specific language or software interface, such as PGL (Printronix Graphics Language used and supported by Printronix of Irvine, Calif), ZPL (Zebra Programming Language used and supported by Zebra Technologies of Illinois), and IPL (Intermec Programming Language used and supported by Intermec of Washington). Other manufacturers with specific languages include TEC and Sato.

Print and apply machine 102 may include a printer data control section that receives the data stream and a printer engine control section for printing the label, as is known in the art. The printer engine control section manages the printer components (e.g., the print head, ribbon motors, platen motor and roller, sensors, etc.) to cause a printed image to be created on the label, based on the received image data.

Print and apply machine 102 is coupled to an X-motor 104, a Y-motor 106, and a Z-motor 108. X-motor enables print and apply machine 102 to move in the X-direction, as shown, such as by driving mechanisms or the machine itself. Similarly, Y-motor 106 and Z-motor 108 enable print and apply machine 102 to move in the Y-direction and Z-direction, respectively, as shown. With three degrees of freedom, printer system 100 is capable of applying a label 110, tag, or other article anywhere on a carton 112 or package, where carton 112 can be different sizes and heights. Details of an application process will be discussed below.

Print and apply machine 102 can include a thermal printer or any other suitable printer. The printer prints the optical information on labels as they pass through the print station. The labels may be in a roll and the roll unwound to expose each label to the print head for printing. “Suitable” printers may also include RFID devices that encode and/or write information onto an RFID tag or label. After the label is printed and/or encoded, an applicator section of machine 102 applies label 110 to carton 112. Print and apply machines are known in the art, such as available through Label-Aire, Weber, and Diagraph RFID labels may also be encoded after being applied to carton 112.

A conveyer system 114 moves cartons 110, which can be packages, boxes, or any other items on which label 11 is to be attached. As each carton 112 passes by the applicator section of machine 102, label 110 with printed barcode or encoded RFID information is attached. Note that barcode, as used herein, may refer to any optically readable format and is not limited to barcodes. Cartons 112 can then be moved along conveyer system 114 for sorting or any other suitable processing.

As discussed above, label 110 can also be encoded with RFID information, such as from a data stream. Note that print and apply machine 102 is labeled as a unitary device. However, depending on the system and/or required function, machine 102 can be separated into two or more devices, such as for printing, encoding, applying, etc. In one embodiment, the existing information is obtained from a data stream transmitted by a host computer (not shown). The data stream can include commands, information, or instructions for printing or encoding information on a label. Print and apply machine 102 can then process the necessary signal components and use the information to print and/or encode a label.

In one embodiment, the data stream also contains information about where label 110 should be placed on carton 112. Along with EPC (Electronic Product Code) data, the data stream may also include location information on the carton. For example, this information may be the distance from the leading edge (or relative front) of the carton (X-direction in FIG. 1) and distance from the interior side of the carton (Y-direction in FIG. 1). The Z-direction may also be included within each data stream, or the Z-direction may be set at a default height, which can be changed in the data stream. X and Y direction placement may also have user-set default settings, where distance information is transmitted by the data stream only if one or more of the default settings are changed. This may occur when a different carton placed on conveyer system 114 or when a different label placement is desired for the same carton. In other embodiments, coordinates for label placement may be sent to printer system 100 separately from the data stream.

The coordinate information, as discussed above, can be sent from a host computer incorporating any third party software such as any warehouse management software, label printing software, SAP drivers, or any database drivers. If the coordinate information is sent with the data stream, the printer system may print/encode the labels and position print and apply machine 102 at the same time, resulting in increased throughput. Once printer system 100 receives an indication, such as through confirmation signals, that both the label is ready and the applicator is properly position, print and apply machine 102 can be brought down (in the Z-direction) to apply the label. Note that the origination of print and apply machine 102 may be positioned at different locations relative to carton 112. For example, if it is desirable to apply labels to one of the sides of carton 112, print and apply machine 102 may be placed along that particular side.

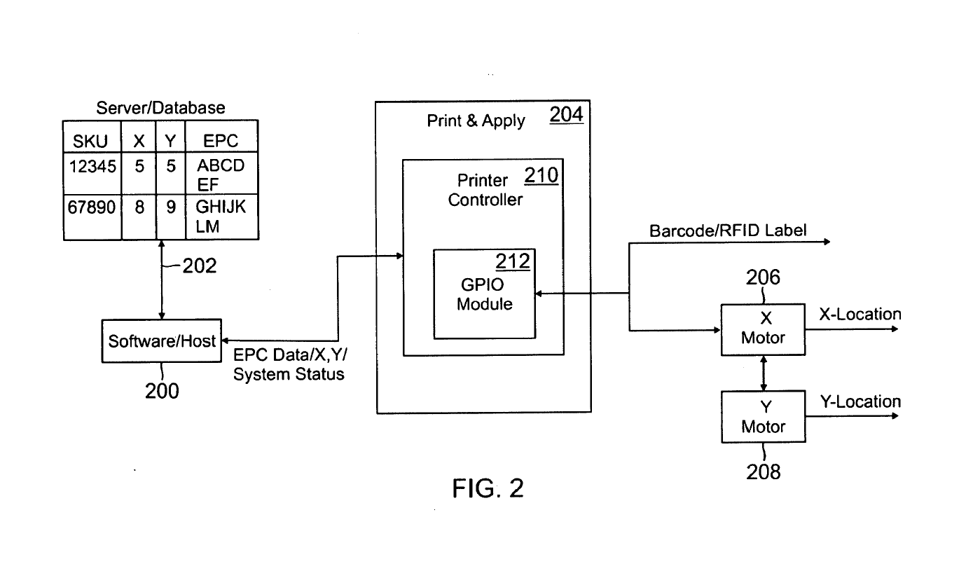

FIG. 2 is a block diagram showing a portion of printer system 100 of FIG. 1. A software/host 200 communicates with a server/database 202 and print and apply machine 204. EPC and coordinate information is stored in server/database 202. Such information may be for different labels and cartons and in different languages. A user may program or write information to server/database 202 for specific printing, encoding, and/or application instructions through any suitable interface. Software/host 200 retrieves coordinate information from server/database and may also retrieve EPC data. Software/host 200 then transmits this information to print and apply machine 204, which routes EPC data to a printer/encoder portion and coordinate data to motors, such as X-motor 206 and Y-motor 208. The printer/encoder portion then prints/encodes the label, while the motors move the applicator portion to the corresponding coordinates. Once each motor positions the application portion in the desired location, a signal is sent to print and apply machine 204. Upon receiving signals from all the motors, the label is applied, assuming the label has been printed or encoded.

In one embodiment, a command parser is used to route the appropriate data to the appropriate destinations. When a data stream that includes both label data and positioning data is received, the command parser may first identify the specific commands for label printing/encoding and the specific data for applicator placement. The command parser then separates the two, and routes the label data to the printer/encoder portion of the system and routes the positioning information to the applicator portion of the system.

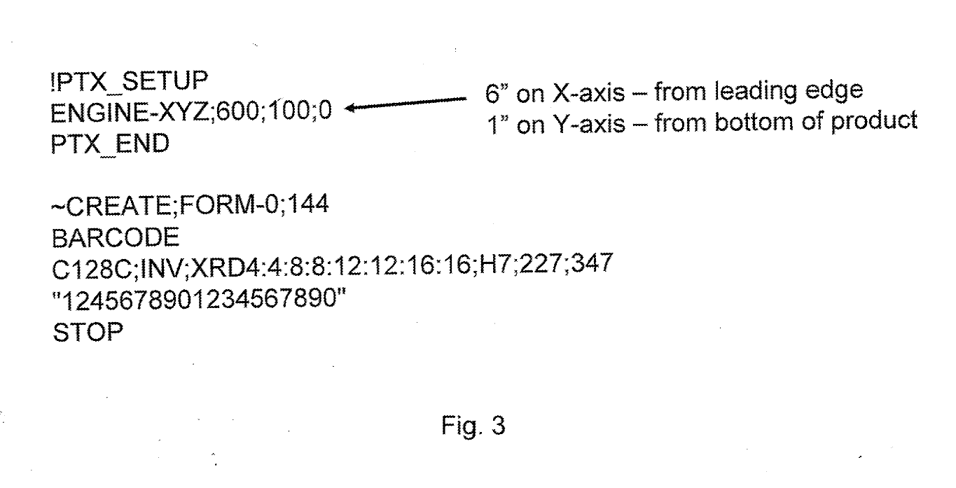

FIG. 3 shows an example command transmitted by software/host 200 to print and apply machine 204. The command in PGL includes instructions to place the label six inches from the leading edge (in the X-direction) and one inch from the bottom of the carton (in the Y-direction) (see FIG. 1). Also included in the command is EPC data for printing a tag. Thus, this example shows a command that includes both barcode information as well as label placement information.

Referring back to FIG. 2, print and apply machine 204 includes a printer controller 210 and a GPIO (general purpose input/output) module 212 for controlling and performing the above actions. GPIO module 212 functions similarly to an input/output intermediate controller next to printer controller 210, acting as a bridge between the printer portion and the applicator portion. GPIO module 212 can be coupled to or integrated with printer controller 210. In conventional systems, EPC data is transmitted to a print and apply device, which prints/encodes the label. Separately, and with a different interface, X and Y data is sent to a PLC/microcontroller, which controls X and Y motors for label placement. With the present invention, a single interface allows one integrated system using a synchronized approach and a single data stream containing both label and placement data.

In one embodiment, GPIO module 212 can be driven by any internal printing, encoding or verification event or by external events. Through mappings, GPIO module 212 can generate output events to drive external devices or to control printer internal activities, resulting in more effective management of functions.

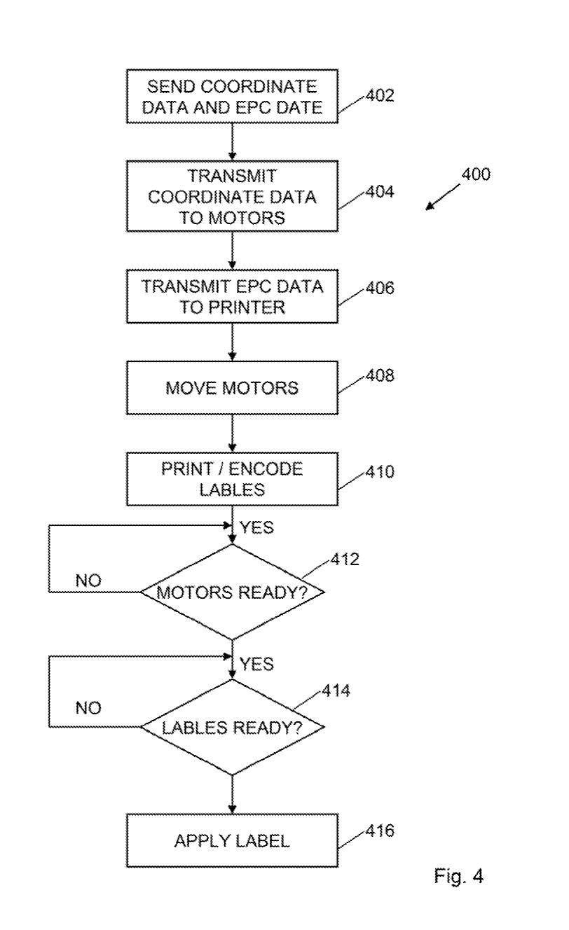

FIG. 4 is a flow chart 400 showing one embodiment for applying a label anywhere on a carton or package. In step 402, label and position information are sent to a print and apply machine. The label information may contain commands, instructions, or data for printing or encoding a label. The position information may contain X, Y, and/or Z coordinates for placement of the label on the carton. Both the label and position information may be transmitted in a single data stream to the print and command machine through a single interface. Next, in step 404, the coordinate data is transmitted to individual motors (e.g., X, Y, and/or Z motors), such as by a printer controller in the print and apply machine. For example, X-coordinate data is transmitted to the X-motor, Y-coordinate data is transmitted to the Y-motor, and Z-coordinate data is transmitted to the Z-motor. Concurrently or subsequently, EPC or label data is transmitted to the printer in step 406. This data is used to instruct the printer portion how to print and/or encode the label.

Next at step 408, in response to the position information transmitted in step 404, the individual motors are moved into the desired positions. Similarly, at step 410, the printer/encoder portion of the printer system prints or encodes labels according to the EPC data received in step 406. This can be done at the same time as the motor movement of step 408. At step 412, the system determines whether the motors are ready, i.e., in the proper position for label application. In one embodiment, this determination is made by checking to see if the system receives a signal from a motor indicating that it is in the proper position. Once the system receives such a signal from each motor, then the system determines that the motors are ready. At step 414, the system determines whether the label is ready, e.g., when printing or encoding is completed. This step may take place at the same time as step 412 or before or after.

When the motors are ready (as determined in step 412) and the label is ready (as determined in step 414), the system applies the label in step 416. In one embodiment, when the label is ready to be applied, a signal is sent to the system for application of the label on the carton. Because the system has independent motors to move the applicator portion anywhere over the carton, the label can be applied anywhere on the carton. Furthermore, because the system has a single integrated controller, both the label printing/encoding information and the label positioning information can be sent to a single interface, in a single data stream. This results in a simple, easy to integrate system that enhances throughput, since label printing and applicator placement can be performed at the same time.

The above-described embodiments of the present invention are merely meant to be illustrative and not limiting. It will thus be obvious to those skilled in the art that various changes and modifications may be made without departing from this invention in its broader aspects. Therefore, the appended claims encompass all such changes and modifications as fall within the true spirit and scope of this invention.

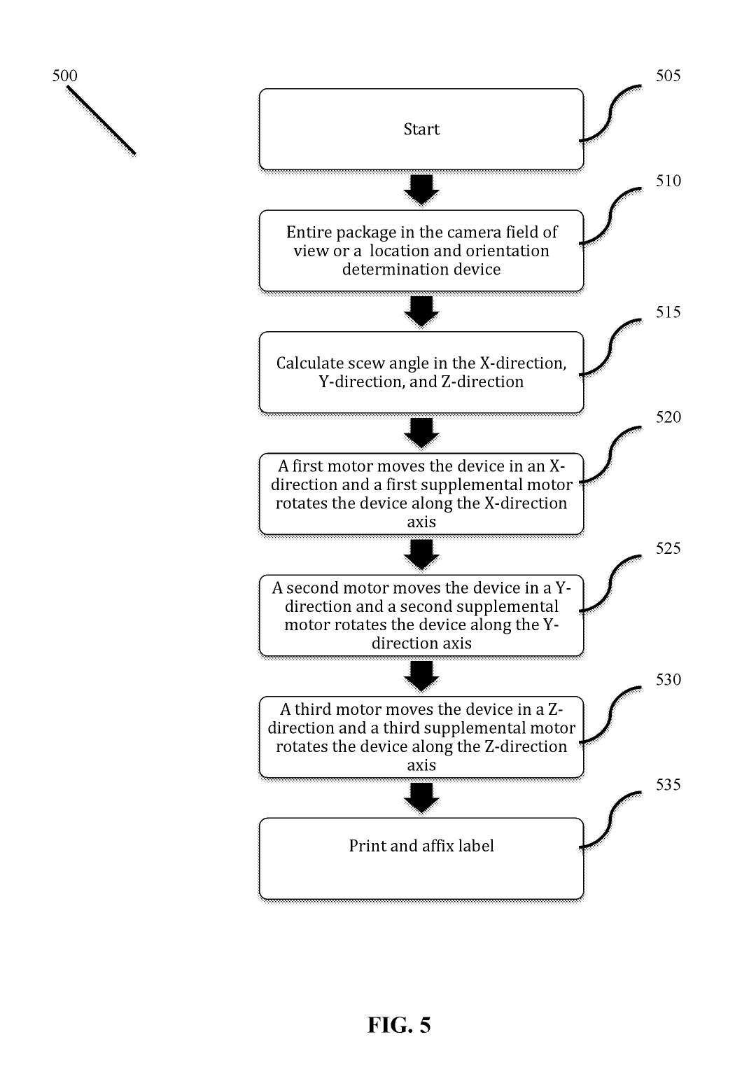

FIG. 5 illustrates the flow diagram 500 for one implementation of the method of skew accommodation used with the printer system. To start 505, a package is placed into the camera field of view 510. An optical sensor detects the skew angle of the package in an X-direction. Y-direction, and Z-direction 515. In one embodiment, the camera can be any type of orientation and location detection apparatus that contains sensors to detect skew angel of an item. A first motor moves the print and apply device in an X-direction and a supplemental motor rotates the print and apply device along the X-direction axis 520. A second motor moves the print and apply device in a Y-direction and a second supplemental motor rotates the print and apply device along the Y-direction axis 525. Lastly, a third motor moves the print and apply device in a Z-direction and a third supplemental motor rotates the print and apply device along the Z-direction axis 530 until the skew angle is determined to be within an acceptable approach to zero. A controller coupled to the print and apply device and having a single interface is configured to receive a single data stream comprising label data and positioning data from a single data stream. A command parser is configured to receive the single data stream and parse label data to the printer/encoder portion and positioning data to the applicator portion. The applicator portion prints and affixes a label to the package 535.

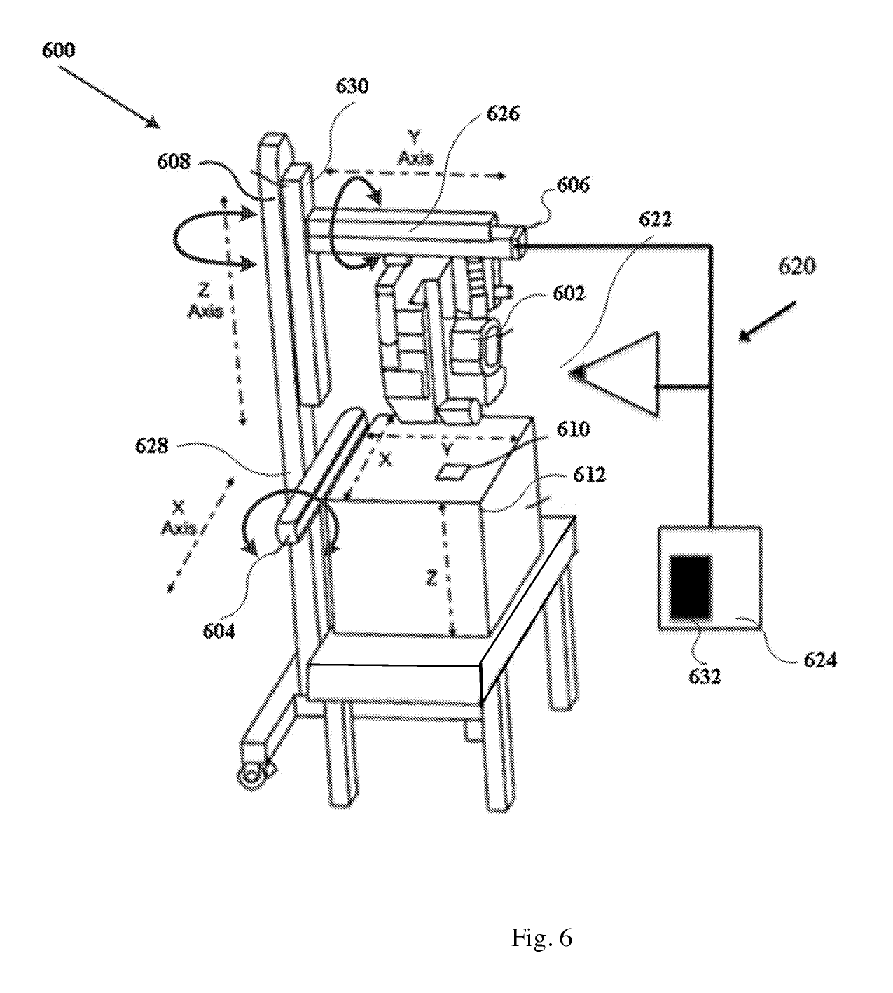

FIG. 6 is a perspective view of one embodiment of the printer system sing a camera and optical sensor for determining package skew 600. In one embodiment, the camera can be any type of orientation and location detection apparatus that contains sensors to detect skew angel of an item. For that matter, the sensors can be an acoustic sensor, a magnetic field sensor, a wireless sensor, a motion sensor, a laser sensor or an air pressure or a weight sensor or any other types of measurement sensors. In one embodiment, the camera 620 consists of an optical sensor 622 which converts the optical image of the package 612 to an electrical file, and a lens which focuses the image of the package 612 onto the sensor 622. The sensor 622 is always imaging ever the printer system 600 is operating, constantly refreshing the image at regular intervals several times per second. A rotation actuator mechanism rotates the camera 620 in an appropriate direction to align the sensor 622 with the package 612. When samples of the image are taken continuously, the skew angle determined by a computer algorithm. The camera 620 continues to be moved in the appropriate direction until the skew angle is determined to be within an acceptable approach to zero. At that time camera 620 motion is stopped. The controller 624 then receives a single data stream comprising label data and positioning data. In response to the position information transmission, the motors 604, 606, 608 and supplemental motors 626, 628, 630 are moved and/or rotated into the desired positions such that a first motor 604 moves the print and apply device in an X-direction and a first supplemental motor 628 rotates the print and apply device along the X-direction axis. Then a second motor 606 moves the print and apply device in a Y-direction and a second supplemental motor 626 rotates the print and apply device along the Y-direction axis. Further, a third motor 608 moves the print and apply device in a Z-direction and a third supplemental motor 630 rotates the print and apply device along the a. Z-direction axis until the skew angle is determined to be within an acceptable approach to zero. Similarly, the controller 624 sends the single data stream to a command parser 632, which parses label data to the printer/encoder portion and positioning data to the applicator portion. The printer and apply 602 portion of the printer system prints or encodes labels 610. This can be done at the same time as the supplemental motor 626, 628, 630 movements. The controller 624 determines whether the supplemental motors 626, 628, 630 are ready, i.e., in the proper skew angle for label 610 application. In one embodiment, this determination is made by checking to see if the controller 624 receives a signal from one or more supplemental motors 626, 628, 630 indicating that it is in the proper position. Once the controller 624 receives such a signal from each motor 626, 628, 630, then the controller 624 determines that the motors are ready. Next, the controller 624 determines whether the label 610 is ready, e.g., when printing or encoding is completed. When the motors 626, 628, 630 are ready and the label 610 is ready, the print and apply system 602 applies the label 610. In one embodiment, when the label 610 is ready to be applied, a signal is sent to the print and apply system 602 for application of the label 610 on the package 612. Because the print and apply system 602 has independent motors 604, 606, 608 to move the applicator portion anywhere over the package 612, the label 610 can be applied anywhere on the package 612. Furthermore, because the print and apply system 602 has a single integrated controller 624, both the label printing/encoding information and the label 610′ positioning information can be sent to a single interface, in a single data stream. The current invention provides a solution that can eliminate the need to reposition the box to align perfectly with the x, y and z axes for the 3 dimension label printer to function properly and to be able to print the label that is aligned to edges thus saving time in aligning the boxes before affixing the label. This revolutionary design yields unexpected results and enables the processing of affixing labels to boxes to be 90% more efficient than the previous embodiment.

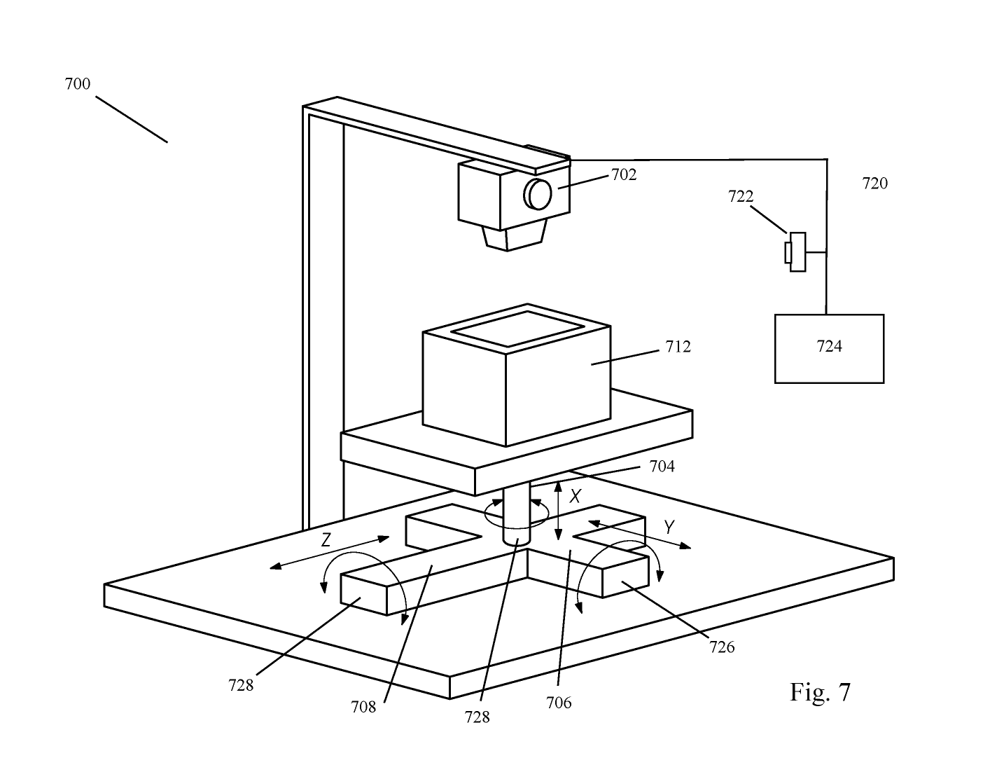

FIG. 7 shows the printer system with a skewed box in view of the x, y, z axes.

The printer system 700 is coupled to an X-motor 704, a Y-motor 706, a Z-motor 708, a supplemental X-motor 728, a supplemental Y-motor 726, and a supplemental Z-motor 730. X-motor 604 enables package 612 to move in the X-direction, as shown, such as by driving mechanisms or the machine itself. A camera 720 comprising a sensor 722 converts the optical image of the package 712 to an electrical file. A rotation actuator mechanism rotates the camera 720 in an appropriate direction to align the sensor 722 with the package 712. When samples of the image are taken, the skew angle determined by a computer algorithm. The camera 720 continues to be moved in the appropriate direction until the skew angle is determined to be within an acceptable approach to zero. At that time camera 720 motion is stopped. The controller 724 then receives a single data stream comprising label data and positioning data. In response to the position information transmission, the supplemental motors 726, 728, 730 are moved into the desired positions such that a first motor 704 and a first supplemental motor 728 moves along the X-direction and rotates the package 712 along the X-direction axis; a second motor 706 and a second supplemental motor 726 moves along the Y-direction and then rotates the package 712 along the Y-direction axis; and a third motor 708 moves along the Z-direction axis and a third supplemental motor 730 rotates the package 712 along the Z-direction axis. With three degrees of freedom, printer system 700 is capable of applying a label, tag, or other article anywhere on a package 712, where the package can be positioned at different angles. Once printer system 700 receives an indication, such as through confirmation signals, that both the label is ready and the print and apply machine 702 is properly positioned, print and apply machine 702 can be brought down (in the x-axis direction) to apply the label.

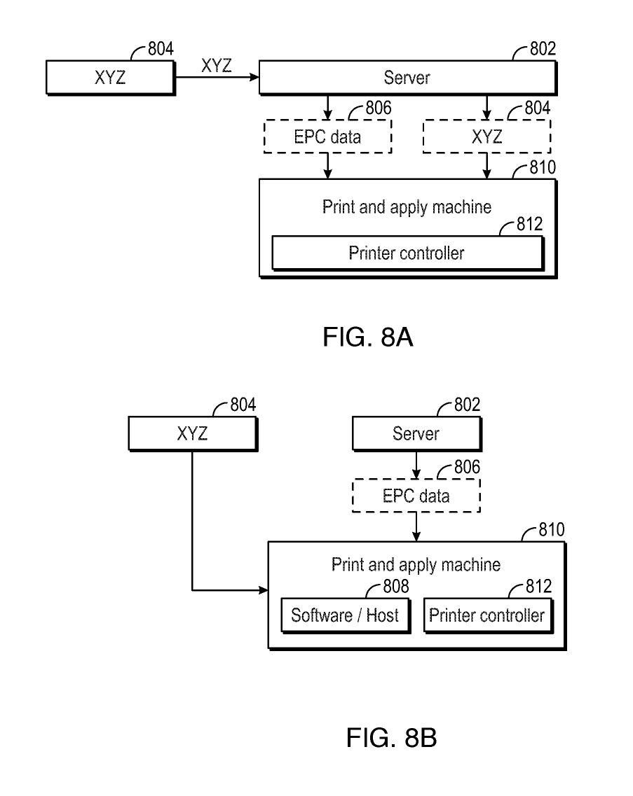

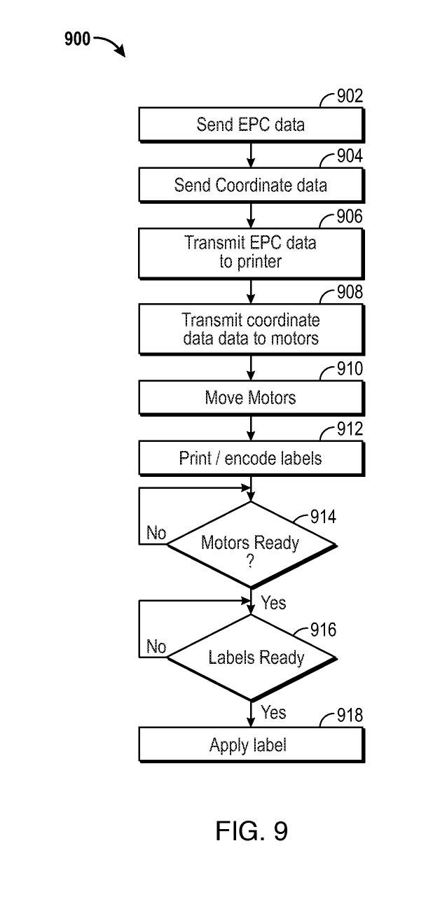

FIG. 8A shows one embodiment wherein the coordinate (XYZ) information 804 is sent with the Electronic Product Code (EPC) data 806 to the server/database 802. The information may be for specific printing, encoding, and application instructions, including information for different labels and different cartons and in different languages, through an interface. The print and apply machine 810 retrieves the coordinate information 804 from the server/database 802 and sends the coordinate data 804 via the printer controller 812 to the corresponding motors.

FIG. 8B shows one embodiment of the invention wherein only the EPC data 806 is sent directly to the server/database 802. The coordinate (XYZ) data 804 is independently and directly transmitted to the print and apply machine 810, which has a software module capable of processing the coordinate information. One advantage of the coordinate information 804 being independently and directly transmitted to the print and apply machine 810 is that the server/database 802 does not need to process this information. This further allows a server/database 802 that may not be capable of processing certain type of coordinate information 804 to still be able to use the method and process of the invention disclosed herein. In one embodiment wherein the coordinate information 804 is separate from the EPC data 806, more potential type of server/database 802, including server/database 802 that cannot process coordinate information 804, can take advantage of the label printer applicator system 810. Additionally, the coordinate information 804 can be provided or managed by anyone since the server/database 802 does not need to process it. This makes it possible for one company to provide products and another to provide packaging services and a third to provide labeling services. The print and apply machine 810 than processes the EPC data 806 and the coordinate data 804 through its software 808 and through its printer controller 812 directs the movement of the printers. This specialization can improve accuracy, efficiency, and cut cost.

What is claimed is:

1. A minter system, comprising:
a print and apply device configured to print or encode a label and apply the label to a package, wherein the device has a printer/encoder portion and an applicator portion;
a first motor to move the print and apply device in an X-direction;
a second motor to move the print and apply device in a Y-direction;
a third motor to move the print and apply device in a Z-direction;
a controller coupled to the print and apply device and having a single interface configured to receive a first single data stream comprising label data from said first single data stream;
and a command parser configured to receive said first single data stream and parse said label data to the printer/encoder;
said controller is further configured to receive a second single data stream comprising positioning data from said second single data stream;
and said command parser configured to receive said second single data stream and parse said positioning data to the applicator portion.

2. The printer system of claim 1 wherein said system is further comprised of a first server hosting and delivering said first single data stream.

3. The printer system of claim 1 wherein said system is further comprised of a second server hosting and delivering said second single data stream.

4. A printer system, comprising:
a print and apply device configured to print or encode a label and apply the label to a package, wherein the device has a printer/encoder portion and an applicator portion; a first motor to move the print and apply device in an X-direction;a second motor to move the print and apply device in a Y-direction;
a third motor to move the print and apply device in a Z-direction;
a first supplemental motor to rotate the print and apply device along the X-axis;
a second supplemental motor to rotate the print and apply device along the Y-axis;
a third supplemental motor to rotate the print and apply device along the Z-axis;
a camera for determining if said package is within field of view;a sensor for detecting skew angle of said package;
a controller coupled to the print and apply device and having a single interface configure(to receive a first single data stream comprising label data from said first single data stream;
and a command parser configured to receive said first single data stream and parse said label data to the printer/encoder;
said controller is further configured to receive a second single data stream comprising positioning data from said second single data stream;
and said command parser configured to receive said second single data stream and parse said positioning data to the applicator portion.

5. The printer system of claim 4 wherein said system is further comprised of a first server hosting and delivering said first single data stream.

6. The printer system of claim 4 wherein said system is further comprised of a second server hosting and delivering said second single data stream.

7. A printer system, comprising:
a first print and apply device configured to print or encode a label and apply one or more label to one or more packages, wherein the device has a printer/encoder portion and an applicator portion;
a first motor to move the print and apply device in an X-direction;
a second motor to move the print and apply device in a Y-direction;
a third motor to move the print and apply device in a Z-direction;
a second print and apply device configured to print or encode a second label and apply said one or more label to said one or more package, wherein the device has a printer/encoder portion and an applicator portion;
a first motor to move the print and apply device in an X-direction;
a second motor to move the print and apply device in a Y-direction;
a third motor to move the print and apply device in a Z-direction;
a switching device that delivers said one or more packages to said first or second print and apply device on request;
a controller coupled to the print and apply device and having a single interface configured to receive a first single data stream comprising label data from said first single data stream;
and a command parser configured to receive said first single data stream and parse said label data to the printer/encoder;
said controller is further configured to receive a second single data stream comprising positioning data from said second single data stream;
and said command parser configured to receive said second single data stream and parse said positioning data to the applicator portion.

8. The printer system of claim 7 wherein said system is further comprised of a first server hosting and delivering said first single data stream.

9. The printer system of claim 7 wherein said system is further comprised of a second server hosting and delivering said second single data stream.

10. A printer system, comprising:
a first print and apply device configured to print or encode one or more label and apply the label to one or more package;
wherein said first print and apply device has a printer/encoder portion and an applicator portion;
a first motor to move the print and apply device in an X-direction;a second motor to move the print and apply device in a Y-direction;
a third motor to move the print and apply device in a Z-direction;
a first supplemental motor to rotate the print and apply device along the X-axis;
a second supplemental motor to rotate the print and apply device along the Y-axis;
a third supplemental motor to rotate the print and apply device along the Z-axis;
a camera for determining if said package is within field of view;
a sensor for detecting skew angle of said package;
a second print and apply device configured to print or encode said one or more label and apply the label to said one or more package;
wherein said second print and apply device has a printer/encoder portion and an applicator portion;
a first motor to move the print and apply device in an X-direction;
a second motor to move the print and apply device in a Y-direction;
a third motor to move the print and apply device in a Z-direction;
a first supplemental motor to rotate the print and apply device along the X-axis;
a second supplemental motor to rotate the print and apply device along the Y-axis;
a third supplemental motor to rotate the print and apply device along the Z-axis;
a camera for determining if said package is within field of view;
a sensor for detecting skew angle of said package;
a switching device that delivers said one or more packages to said first or second print and apply device on request;
a controller coupled to the print and apply device and having a single interface configured to receive a first single data stream comprising label data from said first single data stream;
and a command parser configured to receive said first single data stream and parse said label data to the printer/encoder;
said controller is further configured to receive a second single data stream comprising positioning data from said second single data stream;
and said command parser configured to receive said second single data stream and parse said positioning data to the applicator portion.

11. The printer system of claim 10 wherein said system is further comprised of a first server hosting and delivering said first single data stream.

12. The printer system of claim 10 wherein said system is further comprised of a second server hosting and delivering said second single data stream.
